(19) United States
(12) Patent Application Publication
(10) Pub. No.: US 2015/0037384 A1
(43) Pub. Date: Feb. 5, 2015

(54) ANTIBACTERIAL MATERIALS INCLUDING WATER-ABSORBENT AND WATER-RESISTANT PROPERTIES, AND METHODS OF MANUFACTURING THE SAME

(71) Applicant: Ashley Cintas, Palm Desert, CA (US)

(72) Inventor: Ashley Cintas, Palm Desert, CA (US)

(21) Appl. No.: 13/957,629

(22) Filed: Aug. 2, 2013

(51) Int. Cl. B32B 5/02; A01N 25/10; B32B 37/16; A01N 25/34; B32B 37/06; B32B 37/14

(52) U.S. Cl. CPC B32B 5/024; B32B 37/06; B32B 37/144; B32B 37/16; A01N 25/34; A01N 25/10; B32B 2313/04; B32B 2367/00; B32B 2307/726; B32B 2307/70; B32B 2307/732; B32B 2307/7265
USPC 424/404; 156/148

(57) ABSTRACT

A material includes a bamboo-based, water-absorbent fabric layer defining an exposed first surface and a second, opposite surface. A water-resistant, antibacterial coating layer covers the second surface of the fabric layer. The material is both water-absorbent and water-resistant, comfortable, recyclable, sanitary, machine washable, drier safe, and environmentally friendly. Such material may be utilized in items such as exercise mats and equipment; household items (both indoor and outdoor) such as rugs, floor mats, place mats, mattress covers, pillow cases, shower curtains, etc.; clothing; footwear; personal accessories; medical drapes, mats, and coverings; etc.

### BACKGROUND

1. Technical Field

The present disclosure relates to antibacterial materials having both water-absorbent and water-resistant properties and methods of manufacturing such materials, which may find particular applicability in the fields of exercise mats; rugs and household mats (both indoor and outdoor); clothing; footwear; personal accessories; household items; medical drapes, mats, and coverings; etc.

2. Background of Related Art

Water-absorbent materials, as the name suggests, are beneficial in that they absorb water, inhibiting water from accumulating on the surface of the material. Thus, water-absorbent materials are often used in the manufacture of rugs, mats, and other surface-coverings, where accumulating water may create slick surfaces, making such surfaces dangerous and/or unusable. Due to the ability to absorb water and other liquids, water-absorbent materials are also used in the manufacture of clothing, footwear, accessories, household items, and medical drapes, mats, and coverings. However, despite the benefits of water-absorbent materials, sanitary considerations limit the use of such materials, require rigorous or time-consuming cleaning regiments prior to re-use, and/or render such materials better suited as single-use, disposable materials.

In contrast to water-absorbent materials, water-resistant materials have the benefit of inhibiting water absorption and, thus, obviate some of the sanitary considerations concerning absorption of water and other liquids, and are generally more readily cleanable. However, such materials suffer from the potential of becoming slippery and may still be susceptible to odor absorption.

### SUMMARY

With respect to materials used in, for example, exercise mats, exercise mat covers, exercise equipment, and exercise equipment covers; household items such as rugs, floor mats, place mats, mattress covers, pillow cases, shower curtains, etc.; clothing; footwear; personal accessories; medical drapes, mats, and coverings; and the like, it has been found that both water-absorbent properties, e.g., the ability to inhibit water from accumulating on the user-supporting or user-contacting surface of the mat, and water-resistant properties, e.g., the ability to inhibit unsanitary fluids and odors from being absorbed into or penetrating through the floor-supporting, surface-supporting, or item-protecting surface of the material, are desirable. Additional desirable properties of such materials may include: sanitary properties, e.g., antimicrobial and/or antibacterial; fire retardant; odorless; recyclable; environmentally friendly; machine washable; drier safe, etc.

Accordingly, and in accordance with embodiments of the present disclosure, a material is provided including a bamboo-based, water-absorbent fabric layer defining an exposed first surface and a second, opposite surface; and a water-resistant coating layer covering the second surface of the fabric layer.

In embodiments, the fabric layer is a woven fabric layer. More specifically, the fabric layer may include bamboo charcoal yarn woven with polyester yarn. The bamboo charcoal yarn may be in a range of 10-25%, by weight, of the fabric layer. In some embodiments, the bamboo charcoal yarn is 15%, by weight, of the fabric layer and the polyester yarn is 85%, by weight, of the fabric layer.

In embodiments, a thickness by weight of the fabric layer is in a range of 200 g per yard to 400 g per yard, measured at a width of 58 inches. In some embodiments, the thickness by weight of the fabric layer is 300 g per yard, measured at a width of 58 inches.

In embodiments, the coating layer is a polyurethane-based coating layer. The coating layer may further include one or more sanitary agents and/or a fire retardant.

A mat provided in accordance with the present disclosure includes the material detailed above. More specifically, the mat includes a body defining a first, user-supporting or user-contacting surface and a second, floor-contacting surface. The body includes a bamboo-based, water-absorbent fabric layer and a water-resistant coating layer covering a surface of the fabric layer. An exposed surface of the fabric layer forms the entire user-supporting surface of the body, while an exposed surface of the coating layer forms the entire floor-contacting surface of the body. The material may be configured similarly to and/or may include any of the features of the material detailed above.

A method of manufacturing a material provided in accordance with present disclosure includes weaving a bamboo charcoal yarn with a polyester yarn to form a water-absorbent fabric layer. The method further includes laminating a water-resistant coating layer onto a surface of the fabric layer. Laminating may be performed via thermal transfer or any other suitable methods. Weaving may be configured such that a thickness by weight of the fabric layer is in a range of 200 g per yard to 400 g per yard, measured at a width of 58 inches, and/or such that the fabric layer includes bamboo charcoal yarn and polyester yarn in proportions within the ranges of 10-25% bamboo charcoal yarn and 75-90% polyester yarn, by weight.

A method of using a material is also provided in accordance with present disclosure. The method includes providing a material including a body defining a first, user-supporting or user-contacting surface and a second, floor-contacting (or other support-surface contacting) surface. The user-supporting surface of the body is defined by a bamboo-based, water-absorbent fabric layer. The floor-contacting (or other support-surface contacting) surface of the body is defined by a water-resistant coating layer. The material may further be configured similar to any of the embodiments above. The method includes positioning the body of the material such that the second, floor-contacting (or other support-surface contacting) surface opposes the floor or other support surface and such that the first, user-supporting or user-contacting surface opposes the user. The user is thus capable of contacting the user-supporting or user-contacting surface during use.

### BRIEF DESCRIPTION OF THE DRAWINGS

Various embodiments of the present disclosure are described with reference to the accompanying drawing figures, wherein:

FIG. 1 is a perspective view of an embodiment of a mat provided in accordance with the present disclosure and made at least partially from the materials and/or manufacturing methods of the present disclosure; and

FIG. 2 is a side view of the mat of FIG. 1.

### DETAILED DESCRIPTION

Various exemplary embodiments of the presently disclosure are described in detail hereinbelow with reference to the drawing figures, wherein like references characters identify similar or identical elements. More specifically, although the present disclosure is detailed below and illustrated in the drawing figures with respect to a mat, it is contemplated that the materials and manufacturing methods of the present disclosure be equally applicable for use with respect to other suitable articles or specific implementations thereof including: exercise mats, exercise mat covers, exercise equipment, and exercise equipment covers; household items (both indoor and outdoor) such as rugs, floor mats, place mats, mattress covers, pillow cases, shower curtains, etc.; clothing; footwear; personal accessories; medical drapes, mats, and coverings; etc.

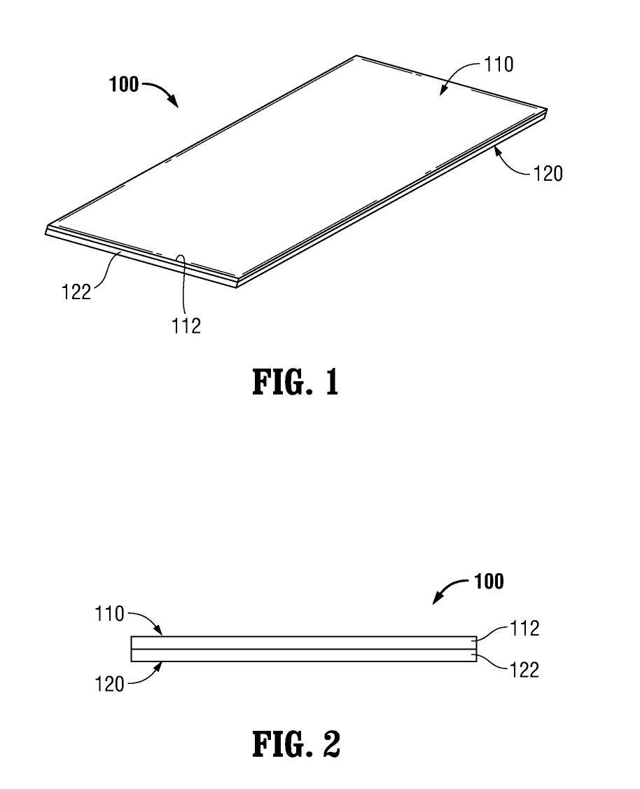

Turning now to FIGS. 1 and 2, a mat provided in accordance with the present disclosure is shown generally designated by reference numeral 100. Mat 100 defines a generally rectangular-shaped configuration, although other configurations are also contemplated, and includes an upper, user-contacting or user-supporting surface 110 and a lower, floor-contacting or other support-contacting surface 120. Mat 100 is formed from a fabric layer 112 having a coating layer 122 disposed on the bottom surface of fabric layer 112 such that fabric layer 112 defines the user-contacting surface 110 of mat 100, while coating layer 122 defines the floor-contacting or other support-contacting surface 120 of mat 100 and inhibits direct contact between fabric layer 112 and the floor or other ground surface. As will be detailed below, mat 100 exhibits both water-absorbent and water-resistant properties, antimicrobial/antibacterial properties, and may be fire retardant, odorless, recyclable, machine washable, drier safe, and/or environmentally friendly.

As mentioned above, mat 100 includes a fabric layer 112 that defines the user-contacting surface 110 of mat 100. Fabric layer 112 is a woven fabric formed from bamboo charcoal yarn and polyester yarn, although fabric layer 112 may additionally be incorporated into or include other woven and/or non-woven materials. For example, as opposed to the polyester yarn or in addition to the polyester yarn, the bamboo charcoal yarn may be woven or otherwise combined with microfiber, spandex, polyester/spandex blends, cotton, cellulose, PET-based materials, and/or other suitable textiles, fabric, yarns, or other materials. As a result of its construction from bamboo charcoal yarn and polyester yarn (and/or other materials), fabric layer 112 is water-absorbent, recyclable, machine washable, drier safe, and environmentally friendly. In addition, fabric layer 112 is comfortable to stand on, lay on, or otherwise contact; the surface texture of fabric layer 112 forms a slip-resistant user-supporting surface 110; and fabric layer 112 is flexible so as to facilitate comfort and allow mat 100 to be rolled-up or folded for transport and/or storage.

The bamboo charcoal yarn comprises 15% of fabric layer 112 by weight, while the polyester yarn (and/or other textiles or yarns) comprises 85% of fabric layer 112 by weight, although it is also envisioned that the fabric layer 112 include bamboo charcoal yarn in the range of 10-25% by weight. The thickness by weight of the fabric layer is 300 g per yard at a width of 58 inches, although other suitable thicknesses by weight in the range of 200 g per yard to 400 g per yard at a width of 58 inches are also contemplated, e.g., depending on the purpose or use. It has been found that 15% bamboo charcoal yarn and 85% polyester yarn, woven to create a fabric layer 112 having a thickness by weight of 300 g per yard at a width of 58 inches provides a desirable balance of liquid absorption, heat absorption, and comfort for use in mat 100 and other similar applications, although the ratio of materials and/or thickness of the fabric layer 112 may vary within our outside the above-noted ranges, depending on a particular purpose or use. In addition, since bamboo charcoal yarn itself is typically limited with respect to color-options to blacks and grays, providing 15% bamboo charcoal yarn as compared to 85% polyester yarn, which is capable of being dyed any suitable color or combination thereof, allows for fabric layer 112 to be dyed a plurality of different colors beyond the blacks and grays of bamboo charcoal yarn.

The bamboo charcoal yarn may be formed from a polyester carrier having embedded bamboo charcoal fibers, although other suitable carriers are also contemplated. Bamboo charcoal yarn is advantageous in that it is naturally moisture and water-absorbent; quick-drying; includes various sanitary properties or natural sanitary agents that are antibacterial, antimicrobial, deodorizing, e.g., capable of neutralizing odorous compounds such as benzene, phenol, methyl alcohol, etc.; inhibits static electricity buildup; provides thermal regulation, e.g., absorbs heat and insulates from cold; provides UV protection; and emits far infrared rays. Polyester yarn is advantageous in that it includes many properties that are similar and complimentary to the properties to the bamboo charcoal yarn, being relatively strong, stretch and shrink resistant, quick-drying, comfortable, and easily washed. Thus, with fabric layer 112, which contains woven bamboo charcoal yarn and polyester yarn, as detailed above, defining the user-contacting surface 110 of mat 100: water, sweat, and other fluids are absorbed by the charcoal bamboo rather than forming puddles on surface 110 or creating a slick surface; odorous compounds in sweat and other fluids in contact with fabric layer 112 are absorbed and neutralized; antimicrobial and antibacterial features help provide a more sanitary user-contacting surface 110; and heat is absorbed without significantly increasing the surface temperature of surface 110. The above listing of advantageous properties is provided to highlight several of the advantages of fabric layer 112 but is not all-inclusive; rather, as can be appreciated, fabric layer 112 includes other advantageous properties not specifically mentioned herein.

As mentioned above, mat 100 includes a coating layer 122 disposed on the under-side of fabric layer 112 that defines the floor-contacting or other support-contacting surface 120 of mat 100. Coating layer 122 may be laminated on the under-side of fabric layer 112 via thermal transfer, although other suitable methods of coating the under-side of fabric layer 112 are also contemplated. Coating layer 122 is a polyurethane-based coating that is both water-resistant and antibacterial. Coating layer 122 forms a film or covering that extends across the under-side of fabric layer 112, to establish an absorption barrier and bacteria barrier on the under-side of fabric layer 112. As such, any bacteria, water, moisture, or liquids on the floor or other support surface are inhibited from being absorbed by mat 100 through coating 122. Likewise, although the exposed upper surface of fabric layer 112 absorbs liquids, any such liquids absorbed by fabric layer 112 are trapped within fabric layer 112 and isolated from the floor or other support surface via coating 122, as they are unable to penetrate coating 122. Thus, the exchange of bacteria, water, moisture, or liquids, in either direction, between mat 100 and the floor or other support surface upon which mat 100 is placed, is inhibited. Further, such a configuration allows surface 120 of mat 100 to be easily wiped-clean.

In addition to water-resistant properties, coating 122 may achieve its antibacterial or other sanitary properties via inclusion of one or more sanitary agents, such as, for example, silver compounds (e.g., silver chloride, silver nitrate, silver oxide), silver ions, silver particles, iodine, povidone/iodine, chlorhexidine, 2-p-sulfanilyanilinoethanol, 4,4′-sulfinyldianiline, 4-sulfanilamidosalicylic acid, acediasulfone, acetosulfone, amikacin, amoxicillin, amphotericin B, ampicillin, apalcillin, apicycline, apramycin, arbekacin, aspoxicillin, azidamfenicol, azithromycin, aztreonam, bacitracin, bambermycin(s), biapenem, brodimoprim, butirosin, capreomycin, carbenicillin, carbomycin, carumonam, cefadroxil, cefamandole, cefatrizine, cefbuperazone, cefclidin, cefdinir, cefditoren, cefepime, cefetamet, cefixime, cefinenoxime, cefminox, cefodizime, cefonicid, cefoperazone, ceforanide, cefotaxime, cefotetan, cefotiam, cefozopran, cefpimizole, cefpiramide, cefpirome, cefprozil, cefroxadine, ceftazidime, cefteram, ceftibuten, ceftriaxone, cefuzonam, cephalexin, cephaloglycin, cephalosporin C, cephradine, chloramphenicol, chlortetracycline, ciprofloxacin, clarithromycin, clinafloxacin, clindamycin, clomocycline, colistin, cyclacillin, dapsone, demeclocycline, diathymosulfone, dibekacin, dihydrostreptomycin, dirithromycin, doxycycline, enoxacin, enviomycin, epicillin, erythromycin, flomoxef, fortimicin(s), gentamicin(s), glucosulfone solasulfone, gramicidin S, gramicidin(s), grepafloxacin, guamecycline, hetacillin, imipenem, isepamicin, josamycin, kanamycin(s), leucomycin(s), lincomycin, lomefloxacin, lucensomycin, lymecycline, meclocycline, meropenem, methacycline, micronomicin, midecamycin(s), minocycline, moxalactam, mupirocin, nadifloxacin, natamycin, neomycin, netilmicin, norfloxacin, oleandomycin, oxytetracycline, p-sulfanilylbenzylamine, panipenem, paromomycin, pazufloxacin, penicillin N, pipacycline, pipemidic acid, polymyxin, primycin, quinacillin, ribostamycin, rifamide, rifampin, rifamycin SV, rifapentine, rifaximin, ristocetin, ritipenem, rokitamycin, rolitetracycline, rosaramycin, roxithromycin, salazosulfadimidine, sancycline, sisomicin, sparfloxacin, spectinomycin, spiramycin, streptomycin, succisulfone, sulfachrysoidine, sulfaloxic acid, sulfamidochrysoidine, sulfanilic acid, sulfoxone, teicoplanin, temafloxacin, temocillin, tetracycline, tetroxoprim, thiamphenicol, thiazolsulfone, thiostrepton, ticarcillin, tigemonam, tobramycin, tosufloxacin, trimethoprim, trospectomycin, trovafloxacin, tuberactinomycin, vancomycin, azaserine, candicidin(s), chlorphenesin, dermostatin(s), filipin, fungichromin, mepartricin, nystatin, oligomycin(s), ciproflaxacin, norfloxacin, ofloxacin, pefloxacin, enoxacin, rosoxacin, amifloxacin, fleroxacin, temafloaxcin, lomefloxacin, perimycin A or tubercidin, and the like. Coating layer 122 may additionally or alternatively include fire-retardant properties by incorporating, for example, cyclic phosphonate esters, zinc borate, or any other suitable fire retardant.

In use, mat 100 is initially placed on a floor or other suitable support surface such that user-contacting surface 110 is upwardly-facing, while the floor-contacting or other support-contacting surface 120 is downwardly-facing. In this position, as mentioned above, user-contacting surface 110, which is defined by fabric layer 112, is exposed to the user to provide a comfortable, moisture and water-absorbent, quick-drying, deodorizing, antibacterial/antimicrobial, thermally regulating surface 110 for the user to contact during use, e.g., standing, laying, walking, eating, working, meditation, stretching, exercising, playing, etc. On the other hand, as also mentioned above, coating layer 122, which defines the floor-contacting or other support-contacting surface 120 of mat 100, inhibits direct contact between fabric layer 112 and the floor or other support surface and serves as a moisture, bacterial, etc. barrier between fabric layer 112 and the floor or other surface without being exposed to the user. Thus, the user avoids direct contact, fluid exchange, and bacteria exchange with the floor or other support surface, while being provided with a more comfortable, slip-resistant, thermally regulated surface; and the user's fluids, e.g., sweat, bacteria, and odors, are inhibited from exchange with the floor or other support surface, to facilitate sanitary conditions at the facility or location where mat 100 is used. After use, mat 100 may be machine washed and dried, or otherwise cleaned/dried, in preparation for reuse.

As can be appreciated, the combination of fabric layer 112 and coating layer 122 as detailed hereinabove provides the benefit of allowing fabric layer 112 and coating layer 122 to maintain both their similar, e.g., antibacterial, and conflicting, e.g., water-absorbent vs. water-resistant, properties in a manner which allows the properties of such layers 112, 122 to cooperate with, rather than diminish, one another. Such a configuration is necessitated by the fact that the desirable properties for user-contacting surface 110 and floor-contacting or other support-contacting surface 120 are different and, in some instances, conflicting.

As mentioned above, the materials of the present disclosure are equally applicable for use in other items other than mats and mat or rug-like items. In particular, with respect to use of the above materials in exercise mat covers, exercise equipment covers, furniture covers, mattress covers, or pillow cases, the material would be oriented such that the fabric layer is exposed to the user (i.e., outwardly-facing), while the coating layer is in contact with the furniture, mat, equipment, mattress, pillow, etc. to be protected (i.e., inwardly-facing). As can be appreciated, the particular orientation of the material with respect to any particular item utilizing or incorporating the materials of the present disclosure may depend on the particular item and/or the desired properties on each surface thereof. Regardless, the materials provide a bacterial and fluid barrier.

The above description and drawing figures should not be construed as limiting, but merely as exemplary of particular embodiments. It is to be understood, therefore, that the disclosure is not limited to the precise embodiments described, and that various other changes and modifications may be effected by one skilled in the art without departing from the scope or spirit of the present disclosure. Additionally, persons skilled in the art will appreciate that the features illustrated or described in connection with one embodiment may be combined with those of another, and that such modifications and variations are also intended to be included within the scope of the present disclosure. Therefore, the above description should not be construed as limiting, but merely as exemplifications of particular embodiments.

What is claimed is:

1. A material, comprising:
a bamboo-based, water-absorbent fabric layer defining an exposed first surface and a second, opposite surface; and
a water-resistant, antibacterial coating layer covering the second surface of the fabric layer.

2. The material according to claim 1, wherein the fabric layer is a woven fabric layer.

3. The material according to claim 1, wherein the fabric layer includes bamboo charcoal yarn woven with polyester yarn.

4. The material according to claim 3, wherein the bamboo charcoal yarn is in a range of 10-25%, by weight, of the fabric layer.

5. The material according to claim 4, wherein the bamboo charcoal yarn is 15%, by weight, of the fabric layer.

6. The material according to claim 5, wherein the polyester yarn is 85%, by weight, of the fabric layer.

7. The material according to claim 3, wherein a thickness by weight of the fabric layer is in a range of 200 g per yard to 400 g per yard, measured at a width of 58 inches.

8. The material according to claim 7, wherein the thickness by weight of the fabric layer is 300 g per yard, measured at a width of 58 inches.

9. The material according to claim 1, wherein the coating layer is a polyurethane-based coating layer.

10. The material according to claim 1, wherein the coating layer further includes one or more sanitary agents.

11. The material according to claim 1, wherein the coating layer includes a fire retardant.

12. A mat or cover, comprising:
a body defining a first, user-contacting surface and a second, opposite surface, the body including a bamboo-based, water-absorbent fabric layer and a water-resistant, antibacterial coating layer covering a surface of the fabric layer, wherein an exposed surface of the fabric layer forms the entire first surface of the body and wherein an exposed surface of the coating layer forms the entire second surface of the body.

13. The mat or cover according to claim 12, wherein the fabric layer includes bamboo charcoal yarn woven with polyester yarn.

14. The mat or cover according to claim 13, wherein the bamboo charcoal yarn is 15%, by weight, of the fabric layer and wherein the polyester yarn is 85%, by weight, of the fabric layer.

15. The mat or cover according to claim 12, wherein a thickness by weight of the fabric layer is 300 g per yard, measured at a width of 58 inches.

16. The mat or cover according to claim 12, wherein the coating layer is a polyurethane-based coating layer including one or more sanitary agents.

17. A method of manufacturing a material, comprising:
weaving a bamboo charcoal yarn with a polyester yarn to form a water-absorbent fabric layer; and
laminating a water-resistant, antibacterial coating layer onto a surface of the fabric layer.

18. The method of claim 17, wherein laminating the coating layer onto the surface of the fabric layer includes thermally transferring the coating layer onto the surface of the fabric layer.

19. The method of claim 17, wherein weaving the bamboo charcoal yarn with the polyester yarn forms a thickness by weight of the fabric layer in a range of 200 g per yard to 400 g per yard, measured at a width of 58 inches.

20. The method of claim 17, wherein the bamboo charcoal yarn and the polyester yarn are woven in proportions within the ranges of 10-25% bamboo charcoal yarn and 75-90% polyester yarn, by weight.
